(19) United States
(12) Patent Application Publication
(10) Pub. No.: US 2002/0067715 A1
(43) Pub. Date: Jun. 6, 2002

(54) Call signalling for IP terminals

(75) Inventors: Rolf Kotthaus, Ludwigsburg (DE); Hans Jurgen Matt, Remseck (DE)

Correspondence Address: SUGHRUE, MION, ZINN, MACPEAK & SEAS, PLLC, 2100 Pennsylvania Avenue, N.W., Washington, DC, 20037-3213, US

(73) Assignee: ALCATEL

(21) Appl. No.: 09/987,983

(22) Filed: Nov. 16, 2001

(30) Foreign Application Priority Data
Nov. 22, 2000 (DE) 100 57 981.7

(51) Int. Cl. H04L 12/66

(52) U.S. Cl. 370/352; 370/356

(57) ABSTRACT

A method for transmitting to an end subscriber, via an IP (=Internet protocol) network (4), signalling information by means of which the end subscriber is informed that a call is being received, via the IP network (4), which is directed to an IP terminal (5) of the end subscriber, connected to the IP network (4), and which, in particular, is intended to transmit video and/or audio signals, for example, human speech signals, is characterized in that the call signalling is effected independently of the Internet protocol, via a special logical transmission channel on a parallel, or the same, physical connection line via which the call is relayed to the IP terminal. A VolP call can thereby be accepted in a simple manner, irrespective of whether or not the IP terminal is switched on or logged-on.

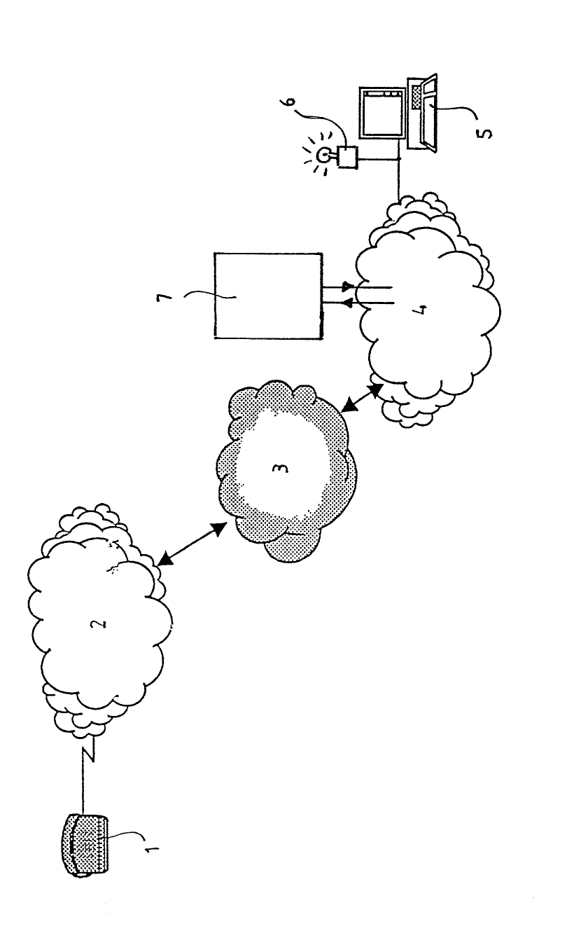

### BACKGROUND OF THE INVENTION

The invention is abased on a priority application DE 100 57 981.7 which is hereby incorporated by reference.

The invention concerns a method for transmitting to an end subscriber, via an IP (=Internet protocol) network, signalling information by means of which the end subscriber is informed that a call is being received, via the IP network, which is directed to an IP terminal of the end subscriber, connected to the IP network, and which, in particular, is intended to transmit video and/or audio signals, for example, human speech signals. Furthermore, the invention also concerns computer programs and facilities for supporting and realizing such a method, in particular, appropriate server units, signalling devices, processor modules and programmable gate array modules.

Internet telephony is becoming increasingly widespread, primarily due to the low charges, particularly in the case of inter-continental connections (USA—Japan—Europe—Australia, etc.). Currently, in this case, communication is preferably between PCs which are each operated with a listening and speech set (headset with microphone).

The PC, by means of a soundblaster card, codes the speech to be emitted into a digital signal which is sent to the partner via the Internet, and decodes the received digital signals back into analog signals which can be heard in the headset.

In order to enable such a PC on the Internet to be connected to an ordinary telephone (POT or ISDN) on the PSTN/GSTN, a PSTN<>IP gateway is required between the conventional telephone network (PSTN or GSTN) and the Internet. At present, this gateway is dealt with in the G.799 of the ITU-T.

It is evident, however, that the specifications and considerations stated therein are not adequate for the establishment of a telephone connection between a telephone on the PSTN and a terminal on the Internet. The same problems also occur in the transmission of video signals for communicating optical information between a terminal in the telephone network and an IP terminal on the Internet.

Although IP terminals such as PCs and laptops can be interconnected by means of a listening/speech headset for the purpose of telephoning, in the case of an incoming telephone call from the PSTN, they can only signal an acoustic-optical signal to the subscriber while they are switched on. If they are switched off, they cannot recognize a call or signal it to the subscriber. At present, therefore, such a telecommunication connection can only be established, and an IP message received on an IP terminal, for as long as the latter is switched on or logged-on.

### SUMMARY OF THE INVENTION

The object of the present invention, by contrast, is to further develop a method of the type initially described, with means which are as simple as possible, so that incoming calls from the Internet by which optical and/or acoustic information is to be transmitted (VolP) can be signalled to the called end subscriber even if the called IP terminal is switched off or logged-off.

According to the invention, this object is achieved, in a manner which is both surprisingly simple and effective, in that the call signalling is effected independently of the Internet protocol, via a special logical transmission channel on a parallel, or the same, physical connection line via which the call is relayed to the IP terminal.

Normally, Internet data is transmitted to the telephone on the ISDN subscriber connection line, preferably on one or two basic channels. In the case of xdSL systems, an ISDN system can be included. Signalling can therefore always be effected via, for example, the ISDN signal channel.

Furthermore, these signals can reach the subscriber via various physical connection lines, for example, via a “conventional” telephone ringer wire, a coaxial cable connection, a wireless connection system (WLL=wireless local loop), a cable television connection (=CaTV), DECT and the like.

The call signalling can then be detected on the called, but switched-off, IP terminal by means of an add-on device and either cause it to be switched on, or logged-on, or relay an optical or acoustic signal to the called end subscriber, via an appropriate add-on device, in order to alert the end subscriber to an incoming call so that the latter can switch on his IP terminal.

Particularly preferred is a variant of the method according to the invention in which a signal channel of an ISDN connection is used as a logical transmission channel for the call signalling. The called IP terminal, or an appropriate add-on device, then registers the incoming call and signals it to the called end subscriber in an appropriate form.

Also advantageous is a variant of the method in which the call signalling is effected through the transmission of a defined frequency by which a signalling device at the called IP terminal can be activated.

Following the arrival of the call signalling, acoustic and/or optical signals are preferably emitted automatically to the called end subscriber in order to alert him to the incoming call.

Additionally or alternatively, in a further preferred variant of the method, following the arrival of the call signalling, the IP terminal of the called end subscriber is automatically switched on and/or logged on. In this way, the incoming call can be actually accepted by the IP terminal and stored if necessary.

For the purpose of providing the calling end subscriber with feedback on the prevailing status of the called IP terminal, in a further variant of the method according to the invention, following the arrival of the call signalling, the calling end subscriber is automatically informed whether the called IP terminal is currently logged-off and/or, if applicable, is soon to be logged-on.

Also particularly preferred is a variant of the method, which can be applied alternatively or in addition, which is distinguished by the fact that, following the arrival of the call signalling, a local mailbox on the called IP terminal and/or a mailbox connected to the IP network is automatically activated if the called IP terminal is currently logged-off or not switched on. The advantages of a mailbox, as have long been known from the domain of telephony, can thus also be exploited for called IP terminals.

In a preferred development of this variant of the method, the mailbox is activated only after the expiry of a period of time, preferably predefinable by the called end subscriber, so that if the called subscriber is not in the vicinity of the IP terminal, he has an opportunity to directly accept the incoming call.

Also advantageous is a further development of the variant of the method described above, in which the called end subscriber can predefine whether, in the case of an incoming call directed to his IP terminal, the IP terminal is switched on and/or logged-on if it is currently switched off or logged-off, or whether a mailbox is to be activated in this case. In this manner, the end subscriber can route calls received in his absence in either direction, as required.

In a particularly preferred variant of the method according to the invention, provision is made whereby a server which, in particular, is connected either to the IP network of the called IP terminal or to the telecommunication network of the calling end subscriber, detects the incoming call and initiates the call signalling for the call directed to the IP terminal irrespective of whether the called IP terminal is switched on or logged-on. The call signalling can be established in a manner similar to that for the known call signalling in the PSTN. It is then relayed by the server to the IP terminal of the called end subscriber via the appropriate network, on a logical channel of the physical Internet connection (generally a telephone line), irrespective of the Internet protocol. When the call signalling arrives at the IP terminal or corresponding add-on device, the measures described above can then be automatically effected if the called IP terminal is switched off or logged-off.

Also included within the scope of the present invention is a server unit, a processor module and a gate array module for supporting the method according to the invention described above, as well as a computer program for implementing the method. The method can be realized both as a hardware circuit and in the form of a computer program. Nowadays, software programming is preferred for powerful DSPs, since new knowledge and additional functions are more easily implemented by changing the software on an existing hardware base. However, methods can also be implemented as hardware components, for example, in IP or telecommunication terminals or conventional telephone sets.

According to the invention, for the purpose of supporting the method described above, a server, in particular, a network server, is equipped with means for detecting a call which contains video and/or audio signals and is directed to an IP terminal, and with means for initiating and emitting signal information to the called IP terminal.

Additionally included within the scope of the present invention is a signalling device for supporting the method according to the invention, with means for receiving signalling information which indicates that there is being received via an IP network a call, in particular, with video and/or audio signals, for example, human speech signals, which is directed to an IP terminal of a called end subscriber which is connected to the IP network, and with means for acoustically and/or optically signalling the incoming call to the called end subscriber and/or with means for activating a mailbox and/or with means for switching on or logging-on the called IP terminal if the latter is currently switched off or logged-off.

The signalling device according to the invention can be modified, in embodiments, in that it has a separate power supply which is independent of the IP terminal. The signalling device can thus respond even if the corresponding IP terminal should be fully disconnected from a power supply.

This can be realized in that, for example, the power supply of the signalling device comprises one or more, preferably rechargeable, batteries, or a separate power supply unit which supplies only the signalling unit, or a remote power feeding of the call detection electronics from the ISDN network.

Alternatively, or additionally, the power supply of the signalling device can comprise a power supply connection to a high-voltage network, for example the 230 V supply network, or to a low-voltage network, for example, to a telecommunication network, in particular, to a telephone network, to an ISDN-NT or, preferably, to the IP network of the called IP terminal.

Further advantages of the invention are disclosed by the description and the drawing. According to the invention, each of the above-mentioned features and those stated below can also be applied either individually or multiply in any combinations. The illustrated and described embodiments are not to be understood as a definitive list, but rather, are of an illustrative nature for the purpose of describing the invention.

### BRIEF DESCRIPTION OF THE DRAWING

The invention is depicted in the drawing and described more fully with reference to embodiment examples.

The figure shows, in highly schematic form, an outline diagram of the mode of operation of a telecommunication connection for the realization of the method according to the invention.

A call is passed from a terminal 1, for example, a “conventional” telephone (POT or ISDN), via a conventional telephone network 2 (PSTN or GSTN=general switched telephone network), to a gateway 3. The gateway 3 connects the telephone network 2 to the Internet 4. Connected, in turn, to the latter is an IP terminal 5 to which the call originating from the terminal 1 is directed. In the present example, the IP terminal 5 is connected to a signalling device 6 according to the invention. Additionally provided in (or on) the Internet 4 is a network server 7 which is equipped with means, not depicted in greater detail in the drawing, for detecting an incoming call, and with means for initiating and emitting signalling information to the called IP terminal 5.

The signalling device 6, in turn, is equipped with means, likewise not depicted in greater detail, for receiving this signalling information, and with means for acoustically and/or optically signalling the incoming call to the called end subscriber and/or with means for activating a mailbox and/or with means for switching on or logging-on the called IP terminal 5 if the latter should currently be switched off or logged-off.

The signalling device 6 can be provided in the form of add-on electronics which can be connected, as a separate box, to an IP terminal 5, for example, a laptop or palmtop, equipped as a telephone PC, or can be incorporated in it, this add-on electronics preferably being separately supplied with power (e.g. by a chargeable battery from the PC or by the 230 V network or by the telephone network or the ISDN-NT). This add-on electronics comprises a telephone sensor, an acoustic-optical signal device and a controller which can be preset from the PC.

If a telephone call from the Internet 4 is registered by the sensor device when the PC is switched off, the acoustic-optical signal device 6 is activated for the duration of the pending call, so that it emits acoustic and/or optical call signals. Depending on the programming of the controller, the PC is either switched on automatically or it is waited until the subscriber comes and releases switch-on of the PC by pressing a button. If the subscriber is absent, a mailbox in the PC or a mailbox in the network is activated—depending on what is preset by the subscriber.

In order for an Internet subscriber to be able to receive a telephone call or fax call when the PC or laptop is switched off, it must be ensured that the subscriber can receive a call although his PC is switched off.

For this purpose, the router or network server 7 assigned to the subscriber contains a special controller or a special control software which recognizes the telephone call or fax call from the Internet 4 and relays it to the IP subscriber, despite the fact that the latter is not currently logged-on to the server, since his PC 5 is switched off.

The transmission of this telephone call can also be signalled to the subscriber equipment, e.g. the ISDN telephones and/or the PC add-on electronics, by the server 7 and the possibly associated ISDN telephone switching system via the signal channel of the ISDN subscriber connection. The add-on electronics can accordingly control the subsequent operation for processing of the call.

1. Method for transmitting to an end subscriber, via an IP (=Internet protocol) network, signalling information by means of which the end subscriber is informed that a call is being received, via the IP network, which is directed to an IP terminal of the end subscriber, connected to the IP network, and which, in particular, is intended to transmit video and/or audio signals, for example, human speech signals, wherein the call signalling is effected independently of the Internet protocol, via a special logical transmission channel on a parallel, or the same, physical connection line via which the call is relayed to the IP terminal.

2. Method according to claim 1, wherein a signal channel of an ISDN connection is used as a logical transmission channel for the call signalling.

3. Method according to claim 1, wherein the call signalling can be activated through transmission of a defined frequency by which a signalling device at the called IP terminal can be activated.

4. Method according to claim 1, wherein, following the arrival of the call signalling, acoustic and/or optical signals are automatically emitted to the called end subscriber.

5. Method according to claim 1, wherein, following the arrival of the call signalling, the IP terminal of the called end subscriber is automatically switched on and/or logged on.

6. Method according to claim 1, wherein, following the arrival of the call signalling, the calling end subscriber is automatically informed whether the called IP terminal is currently logged off but is soon to be logged-on, if applicable.

7. Method according to claim 1, wherein, following the arrival of the call signalling, a local mailbox on the called IP terminal and/or a mailbox connected to the IP network is automatically activated if the called IP terminal is currently logged-off or not switched on.

8. Method according to claim 7, wherein the mailbox is activated only after the expiry of a period of time, preferably predefinable by the called end subscriber.

9. Method according to any one of claims 5 to 8, wherein the called end subscriber can predefine whether, in the case of an incoming call directed to his IP terminal, the IP terminal is switched on and/or logged-on if it is currently switched off or logged-off, or whether a mailbox is to be activated in this case.

10. Method according to claim 1, wherein a server which, in particular, is connected either to the IP network of the called IP terminal or to the telecommunication network of the calling end subscriber, detects the incoming call and initiates the call signalling for the call directed to the IP terminal irrespective of whether the called IP terminal is switched on or logged-on.

11. Server unit for supporting the method according to claim 10, in particular, a network server, with means for detecting a call which contains video and/or audio signals and is directed to an IP terminal, and with means for initiating and emitting signal information to the called IP terminal.

12. Signalling device for supporting the method according to claim 1, with means for receiving signalling information which indicates that there is being received via an IP network a call, in particular, with video and/or audio signals, for example, human speech signals, which is directed to an IP terminal of a called end subscriber which is connected to the IP network, and with means for acoustically and/or optically signalling the incoming call to the called end subscriber and/or with means for activating a mailbox and/or with means for switching on or logging-on the called IP terminal if the latter is currently switched off or logged-off.

13. Signalling device according to claim 12, wherein the signalling device has a power supply which is independent of the IP terminal.

14. Signalling device according to claim 13, wherein the power supply of the signalling device comprises one or more, preferably rechargeable, batteries.

15. Signalling device according to either of claims 13 or 14, wherein the power supply of the signalling device comprises a power supply connection to a high-voltage network, for example the 230 V supply network, or to a low-voltage network, for example, to a telecommunication network, in particular, to a telephone network, to an ISDN-NT or, preferably, to the IP network of the called IP terminal.

16. Processor module, in particular, digital signal processor (=DSP) for supporting the method according to claim 1.

17. Programmable gate array module for supporting the method according to claim 1.

18. Computer programme for realizing the method according to claim 1.
